(19) United States
(12) Patent Application Publication
(10) Pub. No.: US 2015/0261897 A1
(43) Pub. Date: Sep. 17, 2015

(54) SIMULATION METHOD, SIMULATION APPARATUS, AND COMPUTER-READABLE RECORDING MEDIUM

(71) Applicant: KABUSHIKI KAISHA TOSHIBA, Tokyo (JP)

(72) Inventors: Takashi KURUSU, Yamato-Shi (JP); Sanae ITO, Yokohama-Shi (JP); Hiroyoshi TANIMOTO, Yokohama-Shi (JP); Hiroki TOKUHIRA, Kawasaki-Shi (JP); Nobutoshi AOKI, Yokohama-Shi (JP)

(21) Appl. No.: 14/329,534

(22) Filed: Jul. 11, 2014

(30) Foreign Application Priority Data
Mar. 12, 2014 (JP) 2014-049446

(51) Int. Cl. G06F 17/50

(52) U.S. Cl. CPC G06F 17/5009; G06F 17/5081

(57) ABSTRACT

According to an embodiment, a simulation method for resistance variations of a plurality of wires includes creating a numerical expression model for the resistance that is a function of parameters of a cross-sectional shape of the wire, based on the resistance calculated in a Monte Carlo Simulation, dividing each of the wires into a plurality of small elements in a length direction, calculating the resistance of each of the small elements by assigning the parameters of the cross-sectional shape characterizing the cross-sectional shape of each of the small elements to the numerical expression model, and calculating a sum of the resistances of the small elements in each of the wires.

### CROSS REFERENCE TO RELATED APPLICATION

This application is based upon and claims the benefit of priority from the prior Japanese Patent Application No. 2014-049446 filed on Mar. 12, 2014 in Japan, the entire contents of which are incorporated herein by reference.

### FIELD

Embodiments described herein relate generally to a simulation method, a simulation apparatus, and a computer-readable recording medium.

### BACKGROUND

The miniaturization of the metal wire in a semiconductor integrated circuit is progressing. The more the miniaturization progresses, the larger the resistance variation in the wire becomes. Therefore, it is necessary to calculate the resistance variations of a plurality of wires.

### BRIEF DESCRIPTION OF THE DRAWINGS

FIG. 1 is a diagram of the relationship between the resistivity and average wire width of a copper wire, calculated in Monte Carlo Simulation.

FIG. 2 is a diagram of the relationship between the resistivity and amplitude of the wire having a sinusoidal LER of which wavelength is 60 nm.

FIG. 3 is a diagram of the distribution of electric conductivity inside wires corresponding to FIG. 2, calculated in Monte Carlo Simulation.

FIG. 4 is a diagram of the relationship between the resistivity and amplitude of the wire having a sinusoidal LER of which wavelength is 15 nm.

FIG. 5 is a diagram of the distribution of electric conductivity inside wires corresponding to FIG. 4, calculated in Monte Carlo Simulation.

FIG. 6 is a diagram showing a simulation result of a locus of an electron in the wire in FIG. 5.

FIG. 7 is a flowchart of a simulation method as a first comparative example.

FIG. 8 is a diagram of an analysis formula model for a resistivity and parameters in the first comparative example.

FIG. 9 is a flowchart of a simulation method as a second comparative example.

FIG. 10 is a flowchart of a simulation method for resistance variations of a plurality of wires according to a first embodiment.

FIG. 11 is a sectional view illustrating a cross-sectional shape of the wire.

FIG. 12 is a diagram of a condition table for creating a numerical expression model for the cross-sectional shape in FIG. 11, and the resistance of each condition calculated using the Monte Carlo simulator.

FIG. 13 is a diagram showing the numerical expression model for the resistance calculated from the condition table and the resistance in FIG. 12.

FIG. 14 is a schematic diagram of a wire with a waveform of an LER having a short-wavelength component and a long-wavelength component, a wire with a waveform of an LER having the short-wavelength component, and a wire with a waveform of an LER having the long-wavelength component.

FIG. 15 is a diagram for describing a method for calculating whole the resistance of the wire with the LER waveform having the long-wavelength component using the numerical expression model and the principle of the series resistance.

FIG. 16 is a flowchart of a simulation method according to a second embodiment.

FIG. 17 is a block diagram of the schematic configuration of a simulation apparatus for resistance variations of a plurality of wires according to a third embodiment.

### DETAILED DESCRIPTION

According to an embodiment, a simulation method for resistance variations of a plurality of wires includes creating a numerical expression model for the resistance that is a function of parameters of a cross-sectional shape of the wire, based on the resistance calculated in a Monte Carlo Simulation, dividing each of the wires into a plurality of small elements in a length direction, calculating the resistance of each of the small elements by assigning the parameters of the cross-sectional shape characterizing the cross-sectional shape of each of the small elements to the numerical expression model, and calculating a sum of the resistances of the small elements in each of the wires.

Prior to the description of embodiments of the present invention, the background to the present invention developed by the inventors will be described.

It is known that the electric resistance of a metal thin film or a metal wire increases more severely than the reduction in the cross-sectional area as the miniaturization of the metal thin film or the metal wire progresses. It is because the miniaturization increases the frequency of collisions of the electrons that carry the current with the surface of the metal, and this increases the electric resistivity. Furthermore, the miniaturization of the grain boundary sometimes causes the size effect because the copper wire used in the semiconductor integrated circuit is formed by a damascene process. Such a phenomenon is generally referred to as the size effect of the resistivity.

It is pointed out that the shape fluctuations referred to as a Line-Edge Roughness (LER) and a Line-Width Roughness (LWR) deteriorate the resistance of the wire in a nanometer-scale miniaturization. The LER is a fine concave-convex structure on the sidewall of the wire. The LWR is a local fluctuation in the wire width caused by the LER.

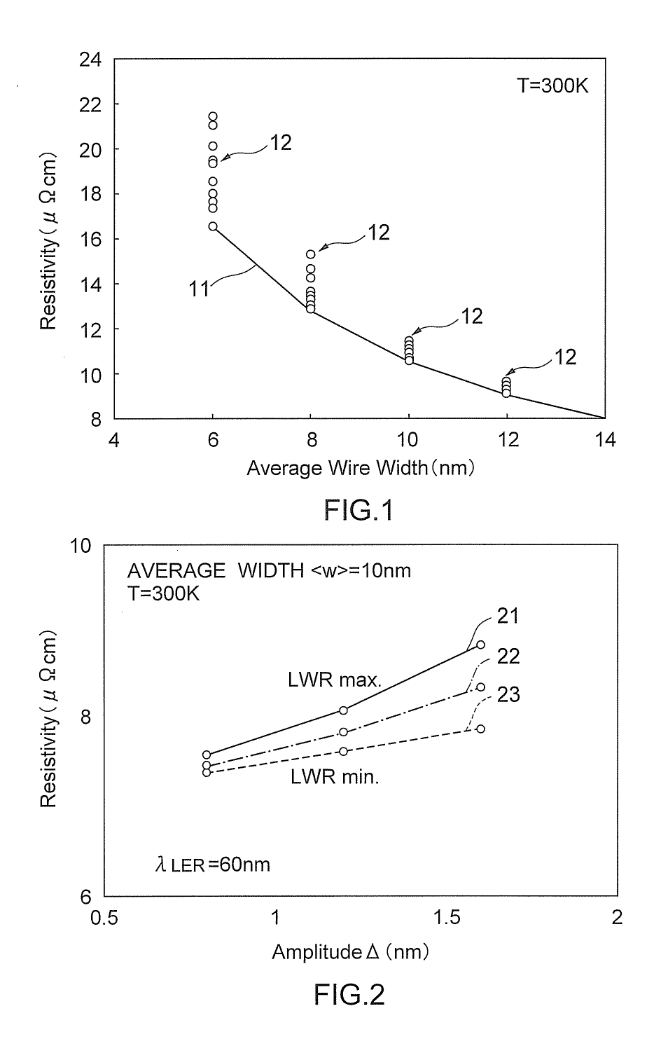

FIG. 1 is a diagram of the relationship between the resistivity and average wire width of a copper wire, calculated in Monte Carlo Simulation. It is assumed that the wire has a rectangular cross-sectional shape and the aspect ratio (horizontal and vertical ratio) of the cross-section of the wire is fixed at two. It is assumed that a temperature is a room temperature (T=300 K). In FIG. 1, a solid line 11 shows the increase in the resistivity regardless of the LER and the LWR. Symbols 12 show the distribution of the resistivity in consideration of the LER and the LWR. The calculation results of ten samples that have different degrees of the LWR per each average wire width are plotted as the symbols 12.

In the example of FIG. 1, the waveform of the LER is generated on the assumption that the cutoff wavelength is 60 nm and the root mean square (hereinafter, referred to as RMS or Δ) of the amplitude is Δ=1.2 nm, and on the assumption that the power spectrum of the LER waveform is a Gaussian function type. As illustrated in FIG. 1, it is found that the increase in the resistivity and the variation in the resistivity due to the LER occur in a nanometer-scale wire.

Next, the mechanism of the increase in the resistivity (the resistance deterioration) due to the LER and the LWR will be described. The mechanism of the increase in the resistivity due to the LER and the LWR varies depending on whether the LER has the wavelength longer or shorter than the mean free path of the electron. The mean free path of the electron is the average distance travelled by the electron between the scatterings in a metal crystal configuring the wire. The mean free path greatly relates to the intensity of the size effect and the resistance deterioration due to the LER and the LWR.

FIG. 2 is a diagram of the relationship between the resistivity and amplitude of the wire having a sinusoidal LER of which wavelength is 60 nm. FIG. 2 illustrates a resistivity 21 of a wire having the maximum LWR, a resistivity 22 of a wire having a medium LWR, and a resistivity 23 of a wire having the minimum LWR. It is assumed that the average width <w> of each wire is 10 nm.

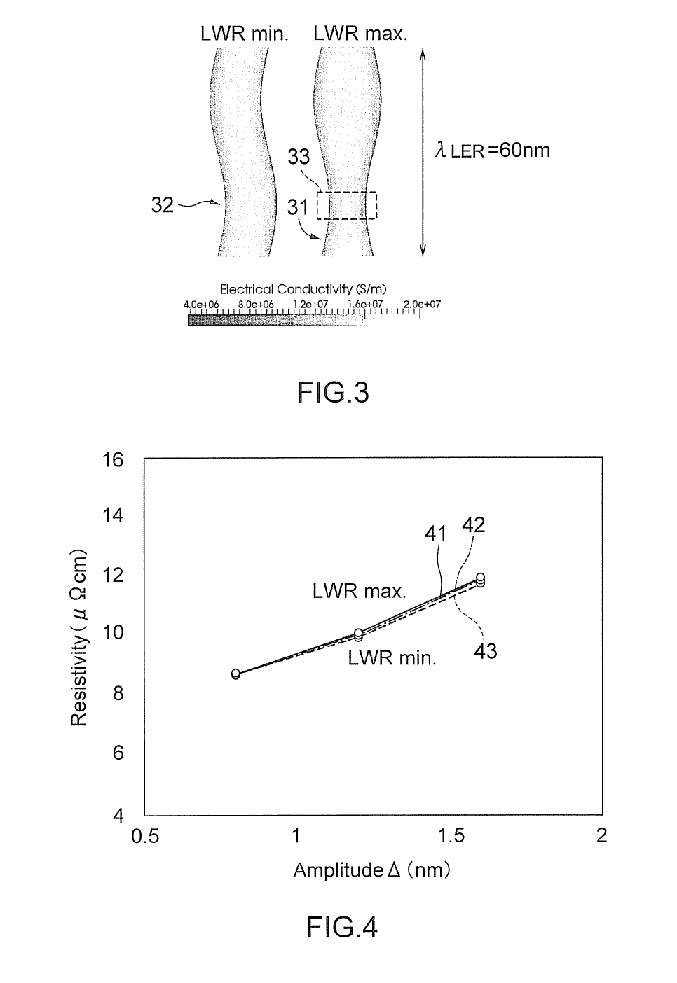

FIG. 3 is a diagram of the distribution of electric conductivity inside wires 31 and 32 corresponding to FIG. 2, calculated in Monte Carlo Simulation. FIG. 3 illustrates the distribution of electric conductivity of a wire 31 that has the maximum LWR and the distribution of electric conductivity of a wire 32 that has the minimum LWR.

In the examples of FIGS. 2 and 3, it is assumed that the material of the wire is copper and the mean free path of the electron is 40 nm. When the LER has a wavelength longer than the mean free path, the increase in the resistivity is caused by the prevention of the flow of current at a bottleneck portion 33 by the LER. In that case, even if the wire has an LER, minimizing the LWR by arranging the waveforms on both sides with each other in the same phase illustrated as the wire 32 in FIG. 3 can suppress the resistance deterioration illustrated as the resistivity 23 in FIG. 2. In such a case in which the LER has a wavelength longer than the mean free path, a method in which the resistance at each length-direction position is calculated by using the analysis formula model for the resistivity and then the resistances at each position is integrated in the length direction can provides an appropriate approximate solution of the electric resistance of the wire with an LER.

FIG. 4 is a diagram of the relationship between the resistivity and amplitude of the wire having a sinusoidal LER of which wavelength is 15 nm. FIG. 4 illustrates a resistivity 41 of a wire having the maximum LWR, a resistivity 42 of a wire having a medium LWR, and a resistivity 43 of a wire having the minimum LWR.

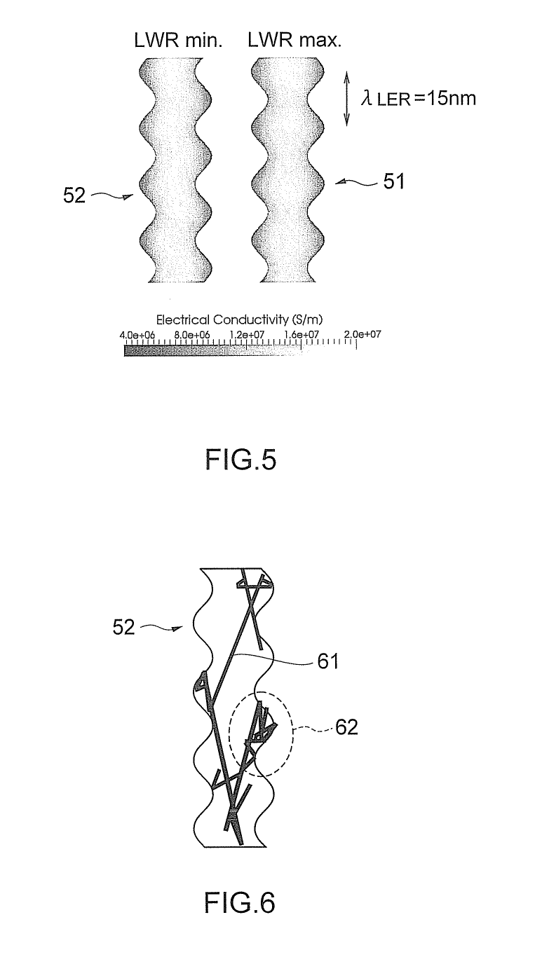

FIG. 5 is a diagram of the distribution of electric conductivity inside wires 51 and 52 corresponding to FIG. 4, calculated in Monte Carlo Simulation. FIG. 5 illustrates the distribution of electric conductivity of a wire 51 that has the maximum LWR and the distribution of electric conductivity of a wire 52 that has the minimum LWR.

In that case, as illustrated in FIG. 4, the resistivity is drastically deteriorated regardless of the presence or absence of an LWR in comparison with FIG. 2.

FIG. 6 is a diagram of a part of a projection 61 of the locus of the electron in the wire 52 in FIG. 5, calculated using Monte Carlo Simulation. When a wire, such as the wires 52 and 51 in FIG. 5, has an LER having a wavelength shorter than the mean free path of the electron, the electron is multiple scattered at the interface of a convex portion like a portion 62 surrounded by a dashed line in FIG. 6. As the result, the convex portions on the sides of the wires 52 and 51 become each a layer that does not contribute to the electric conduction (a dead layer). Accordingly, it is difficult to suppress the resistance deterioration by arranging the waveforms on both sides of the wire with each other. Furthermore, in that case, the dead layer causes the calculation of the increase in the resistance due to an LER using the principles of the series resistance to be inappropriate. For example, the principles of the series resistance lead to the result that the increase in the resistance due to LER does not occur in the wire 52 in FIG. 5. The result is inconsistent with the result from the highly accurate Monte Carlo Simulation.

As described above, the electric resistance of a nanometer-scale metal wire is the function of the parameters characterizing the LER and the LWR in addition to the parameters characterizing the material of the wire and the cross-sectional shape of the wire. In other words, to accurately simulate the resistance variation in the nanometer-scale metal wire, it is necessary to consider the effect of the increase in the resistance due to the LER and the LWR.

### COMPARATIVE EXAMPLE

Next, two simulation methods for the resistance variation in consideration of the resistance deterioration due to an LER and an LWR will be described as comparative examples.

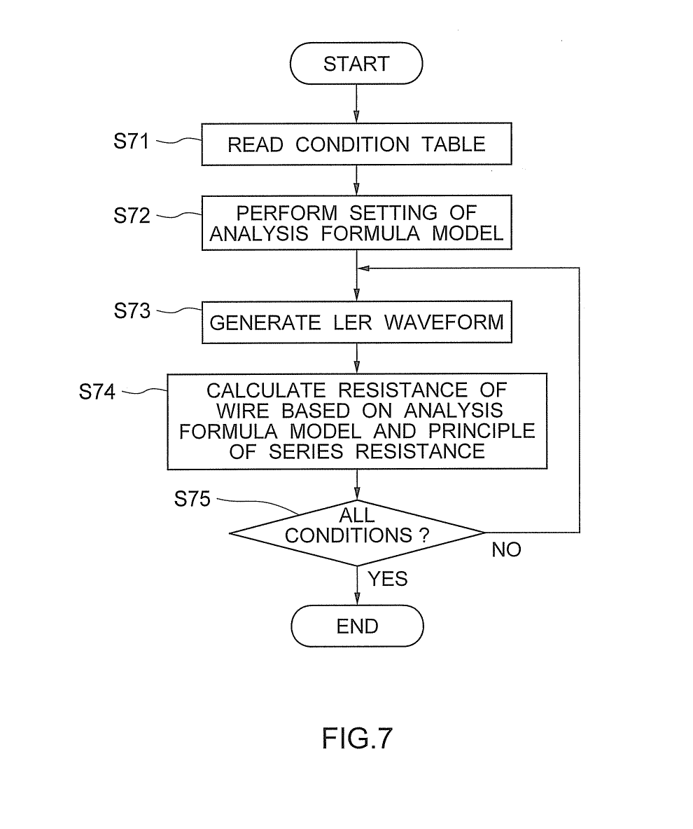

FIG. 7 is a flowchart of a simulation method as a first comparative example. The first comparative example is a resistance variation simulation in consideration of the size effect of the resistivity and the increase in the resistivity due to the LWR, based on a method that is a combination of an analysis formula model in which the resistivity is shown as the function of the width and height of the wire, and the principle of the series resistance.

This method generally includes step S71 of reading a condition table including the types and shapes of a plurality of wires of which resistance variations are to be calculated, step S72 of performing the settings of the analysis formula model for the resistivity, and resistance variation calculation steps S73 to S75 of calculating the resistance for each condition (of each wire) in the read condition table.

In step S71, a common parameter common to all the calculations and a condition table about the wire shape are read. The common parameter is, for example, the type (material and process) or temperature of the wire of which resistance variation is to be simulated. The condition table is a list of the widths and aspect ratios (horizontal and vertical ratios) that are the parameters of the cross-sectional shapes of a plurality of wires of which resistance variations are to be calculated, the power spectra of the LER waveforms (such as, a Gaussian function type or an exponential function type) that are the parameters of an LER and an LWR, the RMS of the amplitude of the LER waveform, and the correlation of the waveforms between edges (or the standard deviation of LWR).

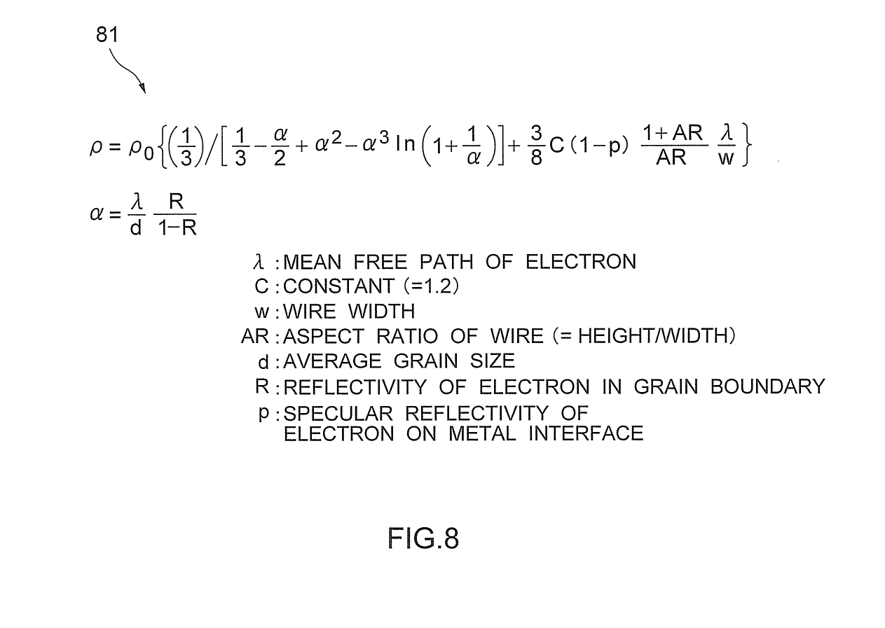

In step S72, the setting of the parameters in the analysis formula model for the resistivity used in the resistance variation calculation steps S73 to S75 are performed. FIG. 8 is a diagram of an analysis formula model 81 for a resistivity ρ and the parameters in the first comparative example. In the analysis formula model 81 for the resistivity ρ illustrated in FIG. 8, the input parameters of the cross-sectional shape are only a wire width w and a wire aspect ratio AR, because it is assumed that the wire has a rectangular cross-sectional shape. The other parameters relate to the increase in the resistance due to the size effect, and are, for example, a specular reflectivity p of the electron on the metal interface, the grain size, and a reflectivity R of the electron in the grain boundary. It is assumed that the relationship between the type and the parameters of the designated wire are tabulated such that the relationship between the resistance and cross-sectional area of the wire actually produced in a similar process to the wire, of which resistance variation is to be calculated, is replicated. In step S72, the parameters are set according to the type of the designated wire.

In the resistance variation calculation steps S73 to S75, the resistances of all the wire shapes designated in the condition table read in step S71 are calculated.

Specifically, in step S73, the LER waveforms on both sides of the wire are generated by the inverse Fourier series expansion, based on the type of the power spectrum designated in the condition table and the parameter.

Next, in step S74, on the assumption that the wire width is fluctuated according to the waveforms, all the resistances of the wire are calculated based on the analysis formula model 81 and the principle of the series resistance.

In step S75, it is determined whether the resistances of the wires of all the conditions in the condition table are calculated. When the resistances are not calculated, the process goes back to step S73 to calculate the resistance in the next condition. When the resistances of the wires of all the conditions are calculated, the process is terminated.

A numerical calculation technique used in the first comparative example has a very high calculation efficiency, because the technique includes only the calculation of the resistance using the analysis formula model 81 and a one-dimensional numerical integration. Accordingly, even many calculation conditions exceeding 100,000 samples can easily and rapidly be simulated. However, there is a problem on the calculation accuracy in that it is difficult to deal with an arbitrary cross-sectional shape, or to consider the resistance deterioration due to the LER with a short wavelength.

An example, in which the resistance is calculated using a Monte Carlo simulator of electron transfer with a higher degree of accuracy in the shape effect than the analysis formula model in the first comparative example, will be described as a second comparative example.

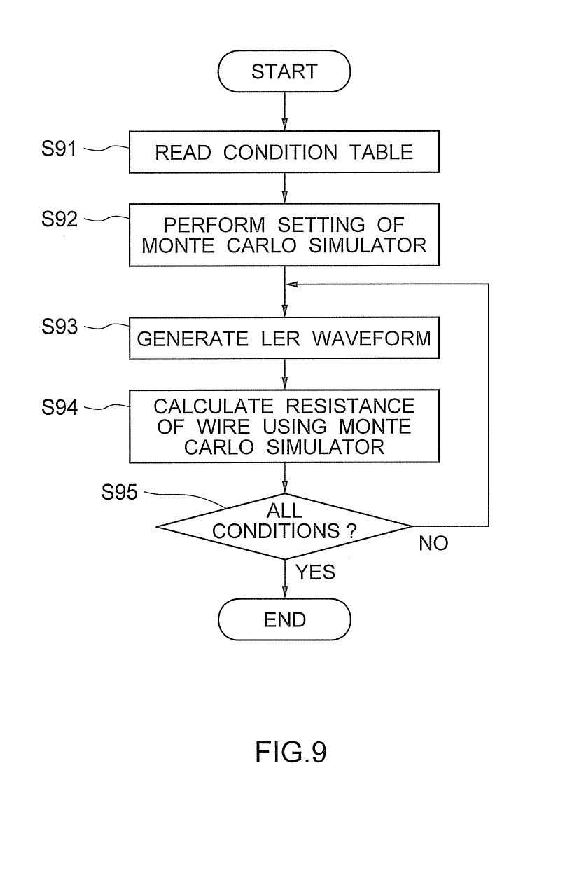

FIG. 9 is a flowchart of a simulation method as the second comparative example. The general flow is the same as the method in the first comparative example. However, differently from the first comparative example, an arbitrary (such as, rectangular, trapezoidal, or polygonal) cross-sectional shape and the numeric parameters characterizing the shape can be designated in step S91, and a Monte Carlo simulator of electron transfer is used to calculate the resistance in resistance variation calculation steps S93 to S95. The Monte Carlo simulator simulates the movement of the electron in the wire in a particle method.

Once receiving an arbitrary cross-sectional shape of the wire and the three-dimensional shape of the wire, the Monte Carlo simulator can calculate the resistance of the shape according to the pre-considered physics model. Specifically, the scattering of the electron in the shape input as the projection 61 in FIG. 6 of the wire is simulated to find the amount of flow of current, namely, the resistance.

As described above, the second comparative example has an advantage that the second comparative example can deal with an arbitrary cross-sectional shape, and the calculation result is highly reliable because being based on a highly accurate physics model. On the other hand, the Monte Carlo Simulation disadvantageously requires a huge calculating machine resource because being a large three-dimensional numeric simulation technology. In other words, it takes a long time to calculate the resistance variations of a plurality of wires.

The inventors have developed the present invention based on the above-mentioned unique knowledge.

Hereinafter, embodiments of the present invention will be described with reference to the drawings. The present invention is not limited to the embodiments.

### First Embodiment

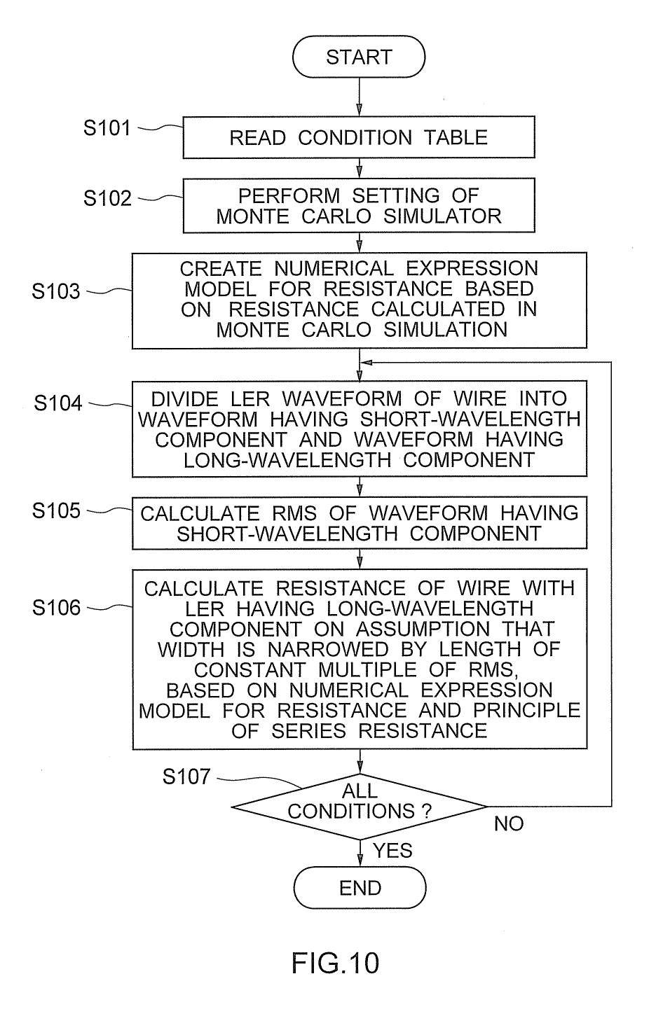

FIG. 10 is a flowchart of a simulation method for the resistance variations of a plurality of wires according to the first embodiment. The wires to be simulated are metal wires in a semiconductor integrated circuit.

As illustrated in FIG. 10, a condition table is read first (step S101). The condition table includes the parameters of an arbitrary (such as, rectangular, trapezoidal, polygonal, circular or elliptical) cross-sectional shape and the conditions for creating a numerical expression model for the resistance to be described below, in addition to the contents of the condition table described in the first comparative example.

Next, the various settings of the Monte Carlo simulator are performed (step S102). Similarly to the first comparative example, the specular scattering probability on the interface is set based on the type of the wire designated through the input.

Next, the numerical expression model for the resistance is created based on the resistance calculated in a highly accurate Monte Carlo Simulation (step S103). The numerical expression model for the resistance is the function of the parameters of the cross-sectional shape of the wire.

Next, the resistance of each of the wires designated in the condition table is calculated using the created numerical expression model (steps S104 to S107).

One of features of the first embodiment lies in including step S103 for creating the numerical expression model for the resistance. In step S103, the numerical expression model for the resistance is created. The numerical expression model is for readily calculating the resistance according to the parameters of the cross-sectional shape and the LER, with the same accuracy as the Monte Carlo Simulation.

A specific process in step S103 will be described below using an example in which the process is applied to the wire having a trapezoidal cross-sectional shape.

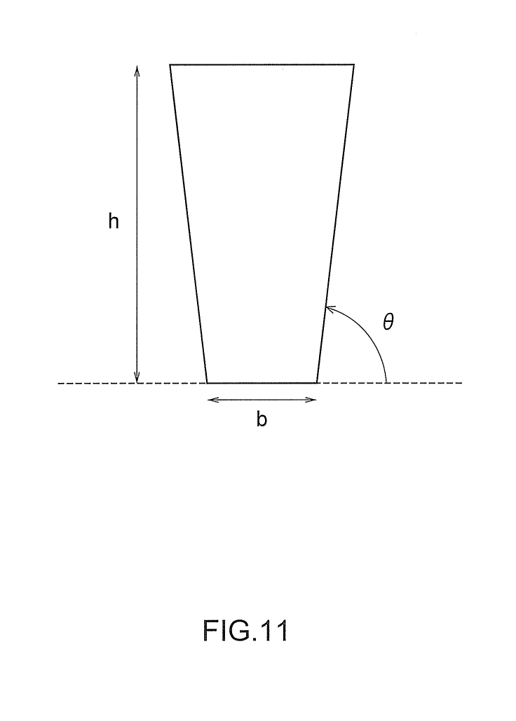

FIG. 11 illustrates the cross-sectional shape of the wire. Three shape parameters, a bottom width b, a height h, and an angle between the bottom and the side (taper angle) θ characterize the trapezoidal cross-sectional shape. Accordingly, in step S103, on the assumption that the resistance per unit length is R, the numerical expression model for the resistance R is created as the function of the parameters of the cross-sectional shape b, h, and θ as the following expression (1).

R=f(b,h,θ) expression (1)

The numerical expression model can be created using a regression analysis technique linked to a design of the experiments or a Taguchi method.

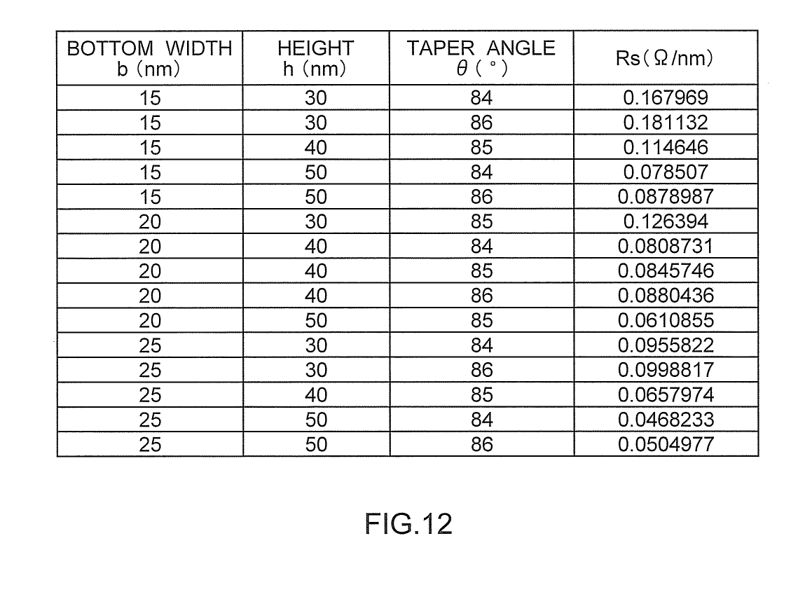

FIG. 12 is a diagram of the condition table (central composite design) for creating the numerical expression model for the cross-sectional shape in FIG. 11, and the resistance Rs of each condition calculated using the Monte Carlo simulator. The condition table includes 15 conditions different from each other and each of the conditions includes the parameters of the cross-sectional shape b, h, and θ.

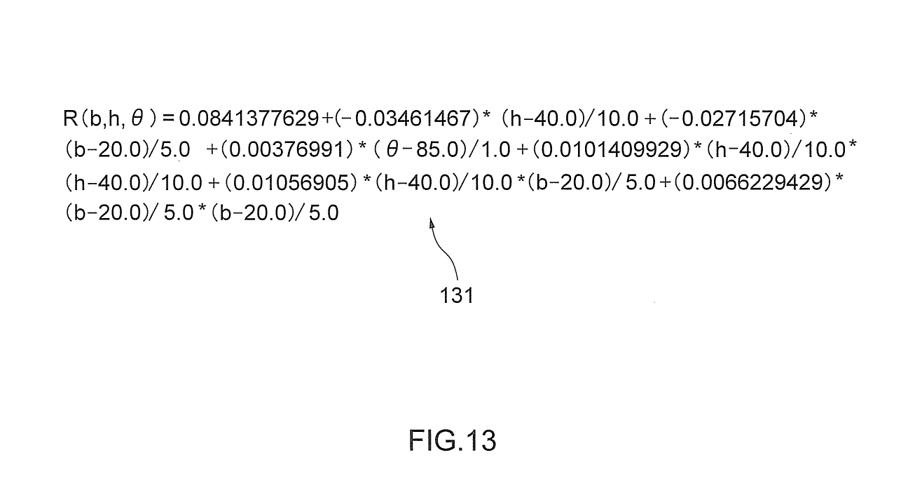

FIG. 13 is a diagram showing the numerical expression model 131 for the resistance R calculated from the condition table and the resistance Rs in FIG. 12, and the regression analysis. The resistance R is the resistance per unit length. The numerical expression model 131 can calculate a corresponding resistance Rs once the parameters of the cross-sectional shape b, h, and 0 of each of the conditions in FIG. 12 are assigned to the model. The numerical expression model 131 includes the linear or quadratic term of each of the parameters of the cross-sectional shape, or an interaction term between the parameters of the cross-sectional shape. However, the numerical expression model can be created only using significant terms for the resistance.

In other words, in step S103, a plurality of reference wire elements having cross-sectional shapes different from each other for creating the numerical expression model 131 is assumed. The resistance per unit length of each of the reference wire elements is calculated in the Monte Carlo Simulation. The numerical expression model 131 is created using the calculated resistance and the parameters of the cross-sectional shape of the reference wire elements. Each of the reference wire elements has a uniform shape in the length direction without an LER.

In the example of FIG. 12, to create the numerical expression model 131, it is necessary to perform the Monte Carlo Simulation 15 times. However, the Monte Carlo Simulation in step S103 according to the present embodiment requires a time for each calculation shorter than the Monte Carlo Simulation for whole the length of the wire with an LER in the second comparative example, because it is necessary only to deal with the reference wire element having a two-dimensional structure without an LER. The number of conditions required to create the numerical expression model tends to increase as the number of the parameters of the cross-sectional shape characterizing the cross-sectional shape increases. However, using an orthogonal table as the condition table requires only 100 conditions at most. This can drastically shorten the calculation time in comparison with the Monte Carlo Simulation with about 100,000 conditions (about 100,000 wires) for the calculation of the resistance variations in the second comparative example. As described above, the number of wires of which resistance variations are to be calculated can be larger than the number of reference wire elements and, for example, can be more than 100 times larger than the number of reference wire elements.

In steps S104 to S107, the resistances of the wires of all the parameters (namely, a plurality of wires) read in step S101 are calculated based on the numerical expression model 131 for the resistance created in step S103 and the principle of the series resistance. Specifically, the sum of the resistances obtained by assigning the parameters of the cross-sectional shape at each length-direction position of each wire to the numerical expression model 131 is calculated.

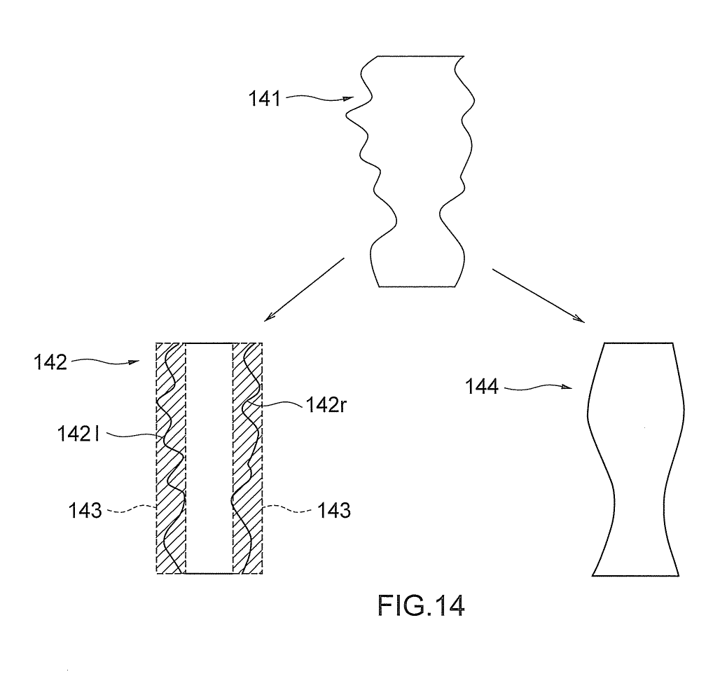

FIG. 14 is a schematic diagram of a wire 141 with an LER having a waveform with wavelengths shorter and longer than the mean free path, a wire 142 with an LER having a waveform with a short wavelength (the short-wavelength component of the LER waveform), and a wire 144 with LER having waveform with a long wavelength (the long-wavelength component of the LER waveform). The wire 141 is a wire of which resistance is to be calculated.

First, in step S104, as illustrated in FIG. 14, the waveform with the short-wavelength component and the waveform with the long-wavelength component of each LER of the wire 141 are separately generated based on the mean free path of the electron in the wire 141, using the power spectrum of each LER waveform of the wire 141. For example, the short-wavelength component is the LER waveform with a wavelength equal to or shorter than the mean free path. The long-wavelength component is the LER waveform with a wavelength longer than the mean free path. The process can readily be conducted because the condition table includes the power spectrum. This can obtain the wire 142 only with the short-wavelength component and the wire 144 only with the long-wavelength component.

Next, in step S105, the RMS (=Δ) of the short-wavelength component in the LER waveform is calculated. The RMS is individually calculated at each of sides 142l and 142r of the wire 142. The RMS of the side 142l is Δleft and the RMS of the side 142r is Δright.

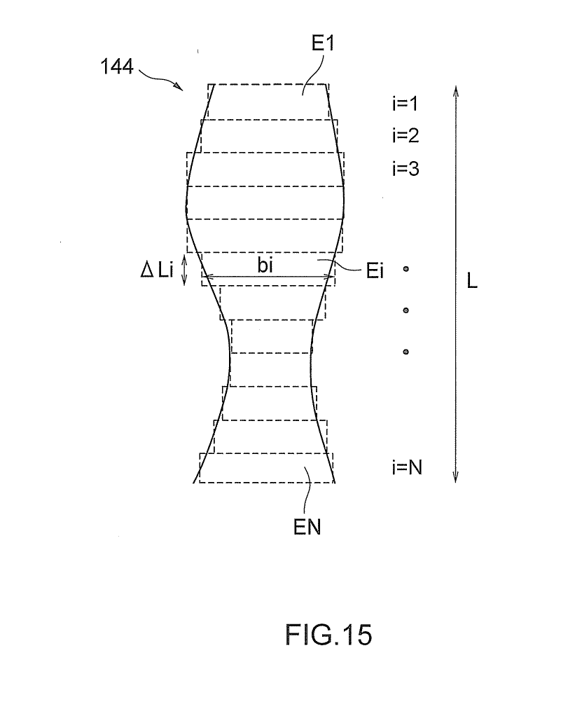

Next, in step S106, the resistance of the wire 144 with the LER waveform having the long-wavelength component is calculated on the assumption that the width is narrowed by the length of the constant multiple of the RMS of the short-wavelength component (the value according to the amplitude of the short-wavelength component), based on the numerical expression model 131 for the resistance and the principle of the series resistance. In other words, on the assumption that the wire 141, of which resistance is to be calculated, has LER waveforms each composed of the long-wavelength component, and the width is narrowed by the length of the constant multiple of the RMS of the short-wavelength component LER, the sum of the resistances obtained by assigning the parameters of the cross-sectional shape at each length-direction position to the numerical expression model 131 is calculated. As described above, the resistance of the wire 144 is calculated in consideration of the dead layer 143 due to the short-wavelength component. As a result, the obtained resistance is equivalent to the resistance of the wire 141. The process will specifically be described with reference to FIG. 15.

FIG. 15 is a diagram for describing a method for calculating whole the resistance of the wire 144 with an LER waveform having the long-wavelength component using the numerical expression model 131 and the principle of the series resistance.

As illustrated in FIG. 15, the wire 144 having a wire length L is divided into a plurality of small elements E1 to EN (N is a positive integer) in the length direction. A length ΔLi (i is an integer from one to N) of the small element is sufficiently shorter than the long-wavelength component of the LER waveform (namely, the mean free path of the electron). A resistance Ri of each small element Ei is calculated using the parameters of the cross-sectional shape of each small element Ei and the numerical expression model 131. Specifically, a resistance ΔRi of each small element Ei is calculated from the following expression (2) using the numerical expression model 131.

ΔRi=f(bi−αΔleft−β·Δright,h,θ)·ΔLi expression (2)

In other words, the parameters of the cross-sectional shape (the average width of the small element Ei (namely, the bottom width) bi, the height h, and the taper angle θ) of the small element Ei, Δleft, Δright, and the length ΔLi of the small element Ei are assigned to the expression (2) to obtain the resistance ΔRi of each small element Ei.

In that case, the α and β are each a constant equal to or larger than zero and is generally a value around six equivalent to the thickness of the dead layer 143 caused by the short-wavelength component. When both of the α and β approach zero, the calculation is asymptotic to the calculation regardless of the resistance deterioration due to the LER with a short wavelength. When it is necessary to calculate the resistance of a wire with a specific LER waveform in which the short-wavelength component partially weakens or disappears, the calculation can be performed while the α and β are partially zero. In that case, the region and value of α and β can be available to input, as the input for the simulation.

Then, the sum of the resistances ΔR1 to ΔRN of the small elements E1 to EN is calculated. The sum becomes whole the resistance of the wire 141.

Next, it is determined in step S107 whether all the wires are calculated. When the calculations are not done, the process goes back to step S104.

Note that, although an example in which the impact of the LER and LWR given on the sides of the wire is considered has been described above, the present invention can readily be applied to the wire having an LER also on the upper surface and the lower surface, not only on the sides of the wire. Each wire can have an LER on at least one of the side, upper surface, and lower surface. At least one of the height and width of each wire can vary in the length direction. Furthermore, the taper angle θ can vary depending on the length-direction position of the wire.

The present invention can readily be applied also to a two-dimensional structure, such as a metal thin film, having an LER on the upper surface and lower surface. In such cases, on the assumption that the height h of the wire is narrowed by the length of the constant multiple of the RMS of the short-wavelength component, the sum of the resistances can be calculated based on the numerical expression model and the principle of the series resistance on the assumption that the height is fluctuated according to the long-wavelength component of the LER waveform. Furthermore, when the wire has a polygonal cross-sectional shape, the wire may have an LER on at least one of the sides forming the wire, and the parameters characterizing the cross-sectional shape can vary in the length direction.

As described above, according to the first embodiment, the numerical expression model 131 for the resistance that is the function of the parameters of the cross-sectional shape is created based on the resistance calculated in a highly accurate Monte Carlo Simulation. As a result, a reliable numerical expression model 131 can be created for an arbitrary cross-sectional shape. Furthermore, the Monte Carlo Simulation is used only for creating the numerical expression model 131. This can suppress the number of execution of the Monte Carlo Simulation.

The LER waveform of the wire 141 is divided into the waveform having the short-wavelength component and the waveform having the long-wavelength component. The resistance of the wire 144 with the LER waveform having the long-wavelength component is calculated on the assumption that the width is narrowed by the length of the constant multiple of the RMS of the short-wavelength component, based on the numerical expression model 131 for the resistance and the principle of the series resistance. This can reflect the impact of the dead layer 143, that does not contribute to the conduction of the electrons, in the calculated resistance. This can calculate the resistance of the wire 141 having an LER with a complicated waveform with the same accuracy as the Monte Carlo Simulation, and can increase the calculation efficiency.

In other words, the resistance variations of several tens of thousands or more of samples of a huge wiring can be simulated with the same high accuracy as the second comparative example and more rapidly than the second comparative example.

This can increase the reliability of the calculation result and the calculation efficiency.

### Second Embodiment

Differently from the first embodiment, the resistance of a wire without an LER waveform having the short-wavelength component is calculated in the second embodiment.

When it is found in advance that the LER has a wavelength longer than the mean free path of the electron, the process in the first embodiment can be simplified as described below.

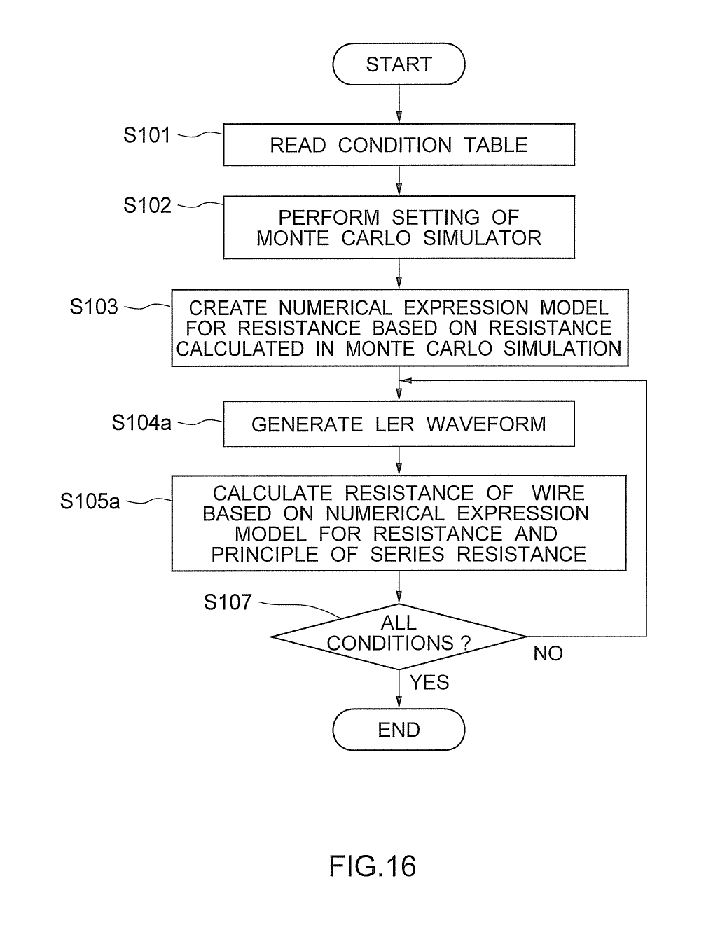

FIG. 16 is a flowchart of a simulation method according to the second embodiment. The process in steps S101 to S103 in FIG. 16 is the same as in FIG. 10. However, the power spectrum included in the condition table does not include a short-wavelength component or includes a short-wavelength component of which amplitude is small enough to be ignored.

After step S103, the resistance of each wire is calculated using the created numerical expression model 131 (steps S104a to S107). Specifically, the sum of the resistances obtained by assigning the parameters of the cross-sectional shape at each length-direction position of each wire to the numerical expression model 131 is calculated.

In step S104a, the LER waveforms on both sides of the wire are created based on the power spectrum designated in the condition table.

In step S105a, the resistance of the wire is calculated based on the numerical expression model 131 for the resistance and the principle of the series resistance. Specifically, similarly to FIG. 15, the wire is divided into a plurality of small elements E1 to EN in the length direction. The parameters of the cross-sectional shape (the average width of the small elements Ei (namely, the bottom width) bi, the height h, and the taper angle θ) of the small element Ei are assigned to the numerical expression model 131 to calculate the product of the obtained resistance R and a length ΔLi of the small element Ei in order to calculate a resistance ΔRi of each of the small elements Ei. The sum of resistances ΔR1 to RN of the small elements E1 to EN is calculated. The sum becomes whole the resistance of the wire.

The process in step S107 is the same process as in FIG. 10.

As described above, the main difference from the first embodiment is that the LER waveform is not divided into the short-wavelength component and the long-wavelength component in the second embodiment. In other words, the constants α and β in the expression (2) of the first embodiment are set at zero in the second embodiment.

As described above, according to the second embodiment, the numerical expression model 131 for the resistance that is the function of the parameters of the cross-sectional shape is created based on the resistance calculated in a highly accurate Monte Carlo Simulation. As a result, a reliable numerical expression model 131 can be created for an arbitrary cross-sectional shape. Furthermore, the Monte Carlo Simulation is used only for creating the numerical expression model 131. This can reduce the number of execution of the Monte Carlo Simulation.

This can also simplify the calculation and increase the calculation efficiency because the resistance of each wire is calculated using the numerical expression model 131 and the principle of the series resistance. When the LER has only a wavelength longer than the mean free path, the bottleneck due to the LWR is a main cause of the resistance deterioration. Accordingly, the calculation method according to the second embodiment does not reduce the calculation accuracy in the resistance deterioration due to LER.

In other words, only for the wire having the structure described above, the resistance variations of several tens of thousands or more of samples of a huge wiring can be simulated with the same high accuracy as the first embodiment and more readily than the first embodiment.

This can increase the reliability of the calculation result and the calculation efficiency.

Note that, according to the second embodiment, each wire can also have an LER on at least one of the side, upper surface, and lower surface, not only on the sides. At least one of the height and width of each wire can vary in the length direction. Furthermore, when the wire has a polygonal cross-sectional shape, the wire can have an LER on at least one of the sides of the wire, and the parameters characterizing the cross-sectional shape can vary in the length direction. When the resistance variation in such a wire is calculated, the same effect as the description can be obtained.

### Third Embodiment

The third embodiment relates to a simulation apparatus in which the simulation method according to the first or second embodiment is performed.

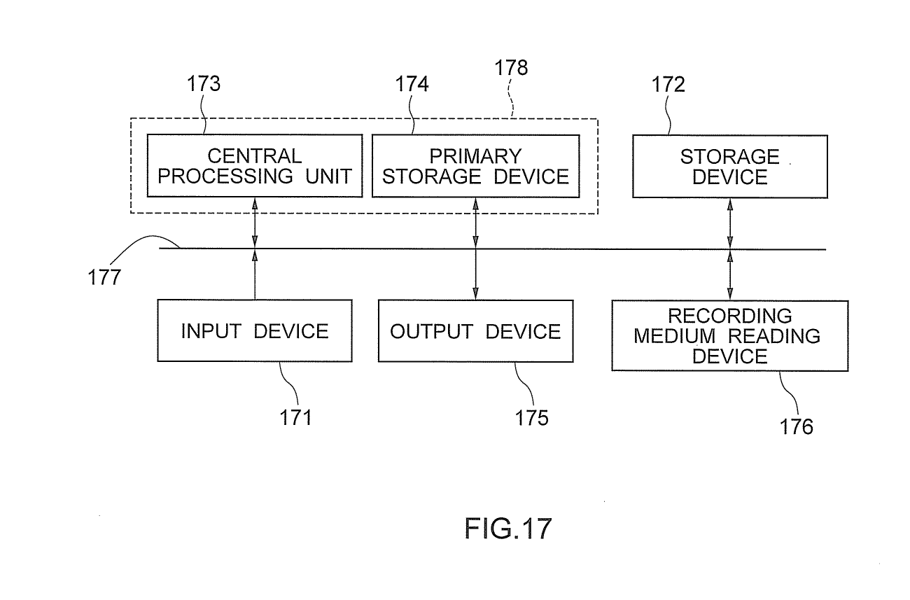

FIG. 17 is a block diagram of the schematic configuration of the simulation apparatus for the resistance variations of a plurality of wires according to the third embodiment. The simulation apparatus includes an input device 171, a storage device 172, a central processing unit (CPU) 173, a primary storage device (memory) 174, an output device 175, a recording medium reading device 176, and a bus line 177.

The input device 171 is a user interface such as a keyboard or a mouse, and inputs the simulation condition such as a condition table.

The storage device 172 is, for example, a hard disk device and stores the input simulation condition, and a simulation program to perform the simulation method according to the first or second embodiment.

The central processing unit 173 and the primary storage device 174 function as an arithmetic device 178. The arithmetic device 178 performs the simulation method according to the first or second embodiment according to the simulation program and simulation condition stored in the storage device 172.

The output device 175 is, for example, a display or a printer, and outputs the resistance of the wire obtained from the calculation in the arithmetic device 178.

The recording medium reading device 176 reads the data from a recording medium. The devices 171 to 176 are connected to each other through the bus line 177.

The simulation apparatus can provide the effect according to the first or second embodiment. In other words, the resistance variation of a wire having an arbitrary cross-sectional shape can be simulated while the calculation cost is not drastically deteriorated.

Note that the simulation method according to the first or second embodiment can be performed by reading the simulation program that performs the simulation method according to the first or second embodiment from a computer-readable recording medium such as an optical medium, a magnetic medium, or a non-volatile memory using the recording medium reading device 176 after storing the simulation program in the recording medium.

Alternatively, the simulation program can be distributed through a communication lines such as the Internet (including a wireless communication). Furthermore, the simulation program can be distributed through a wired network or a wireless network such as the Internet or after being stored in a recording medium, while the simulation program is encrypted, modulated, or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A simulation method for resistance variations of a plurality of wires, the method comprising:
creating a numerical expression model for the resistance that is a function of parameters of a cross-sectional shape of the wire, based on the resistance calculated in a Monte Carlo Simulation;
dividing each of the wires into a plurality of small elements in a length direction;
calculating the resistance of each of the small elements by assigning the parameters of the cross-sectional shape characterizing the cross-sectional shape of each of the small elements to the numerical expression model; and
calculating a sum of the resistances of the small elements in each of the wires.

2. The simulation method according to claim 1, wherein each of the wires has a Line Edge Roughness (LER) on at least one of a side, an upper surface, and a lower surface,
the simulation method further comprising dividing a waveform of each LER of each of the wires into a waveform having a short-wavelength component and a waveform having a long-wavelength component, based on a mean free path of an electron, and
wherein the dividing each of the wires, the calculating the resistance of each of the small elements, and the calculating the sum of the resistances of the small elements are performed on an assumption that the waveform of each LER of each of the wires is composed of the long-wavelength component and that at least one of a width and height of each of the wires is narrowed by a length of a value corresponding to an amplitude of the short-wavelength component.

3. The simulation method according to claim 2, wherein the value corresponding to the amplitude of the short-wavelength component is a constant multiple of a root mean square of the amplitude of the short-wavelength component.

4. The simulation method according to claim 2, wherein
the short-wavelength component is an LER waveform that is a wave with a wavelength equal to or shorter than the mean free path, and
the long-wavelength component is an LER waveform that is a wave with a wavelength longer than the mean free path.

5. The simulation method according to claim 2, wherein the dividing the waveform of each LER into the waveform having the short-wavelength component and the waveform having the long-wavelength component is performed by using a power spectrum of the waveform of each LER of each of the wires.

6. The simulation method according to claim 1, wherein a length of each of the small elements is shorter than a mean free path of an electron.

7. The simulation method according to claim 2, further comprising calculating the resistance of each of a plurality of reference wire elements having cross-sectional shapes different from each other in the Monte Carlo Simulation,
wherein the creating the numerical expression model is performed by using the calculated resistance and parameters of the cross-sectional shape of the reference wire elements.

8. The simulation method according to claim 7, wherein
each of the reference wire elements has a uniform shape in the length direction, and
the numerical expression model provides the resistance per unit length of each of the reference wire elements.

9. The simulation method according to claim 7, wherein a number of the wires is more than 100 times larger than a number of the reference wire elements.

10. The simulation method according to claim 1, wherein each of the wires has an LER on at least one of surfaces forming the wire.

11. The simulation method according to claim 1, wherein at least one of the height and width of each of the wires varies in the length direction.

12. The simulation method according to claim 1, wherein the wires are metal wires in a semiconductor integrated circuit.

13. The simulation method according to claim 1, wherein the cross-sectional shape is polygonal.

14. The simulation method according to claim 1, wherein the cross-sectional shape is circular or elliptical.

15. The simulation method according to claim 1, wherein the creating the numerical expression model is performed by using a design of the experiments or a Taguchi method.

16. A simulation apparatus for resistance variations of a plurality of wires, the apparatus comprising:
an input device configured to input a simulation condition;
a storage device configured to store the simulation condition and a simulation program;
an arithmetic device configured to, according to the simulation program and the simulation condition stored in the storage device, create a numerical expression model for the resistance that is a function of parameters of a cross-sectional shape of the wire, based on the resistance calculated in a Monte Carlo Simulation, divide each of the wires into a plurality of small elements in a length direction, calculate the resistance of each of the small elements by assigning the parameters of the cross-sectional shape characterizing the cross-sectional shape of each of the small elements to the numerical expression model, and calculate a sum of the resistances of the small elements in each of the wires; and
an output device configured to output the resistances of the wires obtained from calculations in the arithmetic device.

17. The simulation apparatus according to claim 16, wherein
each of the wires has a Line Edge Roughness (LER) on at least one of a side, an upper surface, and a lower surface,
the arithmetic device divides a waveform of each LER of each of the wires into a waveform having a short-wavelength component and a waveform having a long-wavelength component based on a mean free path of an electron, and
the arithmetic device divides each of the wires, calculates the resistance of each of the small elements, and calculates the sum of the resistances of the small elements on an assumption that the waveform of each LER of each of the wires is composed of the long-wavelength component and that at least one of a width and height of each of the wires is narrowed by a length of a value corresponding to an amplitude of the short-wavelength component.

18. A computer-readable recording medium storing a program for causing a computer to perform the simulation method according to claim 1.

19. A computer-readable recording medium storing a program for causing a computer to perform the simulation method according to claim 2.
